(19) United States
(12) Patent Application Publication
(10) Pub. No.: US 2023/0356007 A1
(43) Pub. Date: Nov. 9, 2023

(54) REUSABLE, RESTERILIZABLE SMART HALF-MASK RESPIRATOR APPARATUS AND SYSTEM

(71) Applicant: Precision ADM Inc., Winnipeg (CA)

(72) Inventors: Branden LITTLE, Winnipeg (CA); Trevor PENNER, Winnipeg (CA); Martin PETRAK, Winnipeg (CA)

(21) Appl. No.: 18/246,267

(22) PCT Filed: Sep. 22, 2021
(86) PCT No.: PCT/CA21/51318

§ 371 Date: Mar. 22, 2023

Related U.S. Application Data
(60) Provisional application No. 63/081,868, filed on Sep. 22, 2020.

(51) Int. Cl. A62B 7/10; A62B 18/02; A62B 18/08

(52) U.S. Cl. CPC A62B 7/10; A62B 18/025; A62B 18/084

(57) ABSTRACT

A respirator apparatus has a mask body, the mask body having a front wall with at least one filter chamber thereon for receiving therein at least one filter cartridge, each of the at least one filter chamber having a chamber sidewall extending outwardly from the front wall; at least one filter cap demountably attachable to the chamber sidewall of a corresponding one of the at least one filter chamber for securing the at least one filter cartridge in the corresponding filter chamber; and at least one strap harness demountably attachable to the chamber sidewall of a corresponding one of the at least one filter chamber, the at least one strap harness comprising a plurality of fastening anchors.

### CROSS-REFERENCE TO RELATED APPLICATIONS

This application claims the benefit of U.S. Provisional Patent Application Ser. No. 63/081,868, filed Sep. 22, 2020, the content of which is incorporated herein by reference in its entirety.

### FIELD OF THE DISCLOSURE

The present disclosure relates generally to respirator apparatus and systems, and in particular to reusable, resterilizable half-mask respirator apparatus and systems, and to reusable, resterilizable smart half-mask respirator apparatus and systems.

### BACKGROUND

Infectious agents related to respiratory systems such as flu (also commonly referred to as influenza), severe acute respiratory syndrome (SARS), Middle East respiratory syndrome (MERS), novel coronavirus (2019-nCoV or SARS-CoV-2; hereinafter, the terms “coronavirus”, “SARS-CoV 2” and “COVID-19” may be used interchangeably) which caused the COVID-19 pandemic pose significant health risks to human society. Some of the respiratory infectious agents are highly contagious and may lead to an epidemic or a pandemic.

While some vaccines have become available for limiting the spread of some respiratory infectious agents such as flu. It is still an open problem of finding suitable and/or highly effective vaccines for combatting other respiratory infectious agents such as SARS, MERS, and/or COVID-19.

It has been accepted that respirator apparatuses and systems with suitable filtering functions may effectively reduce or even stop the spread of respiratory infectious agents. One type of respirator apparatuses is disposable masks which generally require disposition after single use for a limited period of time. Wide use of disposable masks in a pandemic is costly. Moreover, wide use of disposable masks by general public may cause huge pressure, issues, and potential hazards to logistics, disposition, and/or recycling.

Reusable masks and other types of respirator apparatuses and systems may alleviate the above-described issues. However, reusable respirator apparatuses and systems also face various challenges such as sealing performance, sanitization or sterilization, reliability, ease of use, and usage tracking.

Therefore, it is a desire to develop novel reusable respirator apparatuses and systems with solutions of at least some of above-described challenges for providing users reliable protection against respiratory infectious agents.

### SUMMARY

The embodiments disclosed here generally relate to reusable, resterilizable respirator apparatus and systems.

According to one aspect of this disclosure, there is provided a respirator apparatus comprising: a reusable and resterilizable mask body, the mask body comprising a front wall with at least one filter chamber thereon for receiving therein at least one filter cartridge, each of the at least one filter chamber comprising a chamber sidewall extending outwardly from the front wall; and at least one disposable filter cap demountably attachable to the chamber sidewall of a corresponding one of the at least one filter chamber for securing the at least one filter cartridge in the corresponding filter chamber; any concave section of the mask body comprises a smoothly curved contour or comprises an obtuse angle measured between two tangential lines thereof.

In some embodiments, any concave section of the mask body has a size allowing a human finger to position therein for using a wipe to clean and sterilize the concave section.

In some embodiments, the front wall of the mask body comprises: a central portion comprising the at least one filter chamber; and a peripheral portion extending from the central portion; the central portion comprises a rigid material; and the peripheral portion comprises a first flexible material.

In some embodiments, the rigid material comprises polypropylene.

In some embodiments, the first flexible material comprises soft thermoplastic elastomers (TPE).

In some embodiments, the mask body further comprises a rear wall extending rearwardly from the front wall, the rear wall comprising an opening in communication with the at least one filter chamber.

In some embodiments, the rear wall comprises a second flexible material.

In some embodiments, the first and second flexible materials are same material.

In some embodiments, the mask body further comprises a transition wall smoothly transitioning between the front and rear walls.

In some embodiments, the transition wall comprises a third flexible material.

In some embodiments, the first, second, and third flexible materials are same material.

In some embodiments, the chamber sidewall of each of the at least one filter chamber comprises a delimit protrusion on the outer surface thereof at the interface between the chamber sidewall and the front wall.

In some embodiments, each delimit protrusion has a frustum shape.

In some embodiments, the chamber sidewall of each of the at least one filter chamber further comprises a sealing edge and a plurality of threads on the outer surface thereof.

In some embodiments, the respirator apparatus further comprises: at least one reusable and resterilizable strap harness demountably attachable to the chamber sidewall of a corresponding one of the at least one filter chamber, the at least one strap harness comprising a plurality of fastening anchors.

In some embodiments, any concave section of the at least one strap harness comprises a smoothly curved contour or comprises an obtuse angle measured between two tangential lines thereof.

In some embodiments, each of the at least one strap harness comprises a delimiter radially outwardly extending a body thereof, the delimiter comprising a rearwardly and radially inwardly facing recess for coupling to the delimit protrusion of the corresponding chamber sidewall.

In some embodiments, each delimiter has a shape substantially corresponding to that of the delimit protrusion of the corresponding chamber sidewall.

In some embodiments, each filter cap is configured for securing a corresponding one of the at least one strap harness to the corresponding chamber sidewall.

In some embodiments, each filter cap comprises a mark for indicating the filter cap being secured to the corresponding chamber sidewall.

In some embodiments, each filter cap comprises an end wall and a sidewall for coupling to the corresponding chamber sidewall.

In some embodiments, each filter cap comprises one or more openings on at least one of the end wall and the sidewall thereof for allowing air to pass through and into the filter cartridge.

In some embodiments, the at least one filter cap is integrated with the filter cartridge.

In some embodiments, the at least one filter cap comprises at least one cartridge housing for receiving the filter cartridge.

In some embodiments, the respirator apparatus further comprises one or more reusable and resterilizable mounting structures for demountably coupling to the plurality of fastening anchors.

In some embodiments, any concave section of the one or more mounting structures comprises a smoothly curved contour or comprises an obtuse angle measured between two tangential lines thereof.

In some embodiments, the one or more mounting structures comprise at least one of: a head mounting strap structure; and a neck mounting structure.

In some embodiments, the head mounting strap structure comprise at least one of: a horizontal strap; and a pair of vertical straps.

In some embodiments, the respirator apparatus further comprises a face shield comprising at least one opening for demountably coupling to the chamber sidewall of the at least one filter chamber for demountably coupling the face shield to the mask body.

In some embodiments, the at least one filter cap is configured for securing the face shield to the mask body.

In some embodiments, the respirator apparatus further comprises one or more communication components for communicating with a communication device.

In some embodiments, the one or more communication components comprise one or more automatic-identification-and-data-capture (AIDC) sensors.

In some embodiments, the one or more communication components comprise one or more radio-frequency identification (RFID) tags.

In some embodiments, the one or more communication components comprise one or more near-field communication (NFC) circuitries.

In some embodiments, the respirator apparatus further comprises one or more temperature sensors.

In some embodiments, the respirator apparatus further comprises one or more bio-sensors for detecting infectious agents from air of a user's breath.

In some embodiments, a system comprises: one or more respirator apparatuses as described above; and one or more computing devices for communicating with the one or more communication components of the one or more respirator apparatuses for tracking usage of the one or more respirator apparatuses and/or inventory management thereof.

In some embodiments, a system comprises: one or more respirator apparatuses as described above; and one or more computing devices for communicating with the one or more communication components of the one or more respirator apparatuses for collecting temperature data from the one or more temperature sensors thereof for tracking use conditions of the one or more respirator apparatuses.

In some embodiments, the one or more computing devices are configured for determining that one of the one or more respirator apparatuses is in use if the temperature data collected therefrom is within a range of human body temperatures.

In some embodiments, the one or more computing devices are configured for determining, based on the temperature data collected from one of the one or more respirator apparatuses, a health condition of a user of the respirator apparatus.

In some embodiments, the one or more computing devices are configured for determining, based on the temperature data collected from one of the one or more respirator apparatuses, that the respirator apparatus is in a reprocessing or reconditioning cycle in an environment of a predefined temperature.

According to one aspect of this disclosure, there is provided a respirator apparatus comprising: a mask body, the mask body comprising a front wall with at least one filter chamber thereon for receiving therein at least one filter cartridge, each of the at least one filter chamber comprising a chamber sidewall extending outwardly from the front wall; at least one filter cap demountably attachable to the chamber sidewall of a corresponding one of the at least one filter chamber for securing the at least one filter cartridge in the corresponding filter chamber; and at least one strap harness demountably attachable to the chamber sidewall of a corresponding one of the at least one filter chamber, the at least one strap harness comprising a plurality of fastening anchors.

### BRIEF DESCRIPTION OF THE DRAWINGS

FIGS. 1 and 2 are perspective views of a reusable, resterilizable respirator apparatus in the form of a half-mask, viewing from different directions;

FIG. 3 is a front view of the reusable, resterilizable half-mask shown in FIG. 1;

FIG. 4 is a rear view of the reusable, resterilizable half-mask shown in FIG. 1;

FIGS. 5 and 6 are side views of the reusable, resterilizable half-mask shown in FIG. 1;

FIG. 7 is a plan view of the reusable, resterilizable half-mask shown in FIG. 1;

FIG. 8 is a bottom view of the reusable, resterilizable half-mask shown in FIG. 1;

FIG. 9 is an exploded view of the reusable, resterilizable half-mask shown in FIG. 1, showing various components thereof;

FIGS. 10A to 10D show the mask body, wherein

FIGS. 10A and 10B are perspective views of a mask body of the reusable, resterilizable half-mask shown in FIG. 1, viewing from different directions, and

FIG. 10C is a plan view of the mask body shown in FIG. 10A, and

FIG. 10D is a bottom view of the mask body shown in FIG. 10A;

FIGS. 11A and 11B are perspective views of portions of the mask body shown in FIG. 10A, illustrating the details of the mask body;

FIG. 12 is a cross-sectional view of the mask body shown in FIG. 10A;

FIGS. 13 and 14 are perspective views of a strap harness of the reusable, resterilizable half-mask shown in FIG. 1, viewing from different directions;

FIG. 15 is a perspective view of a fastening structure of the strap harness shown in FIG. 13;

FIGS. 16 and 17 are perspective views of a filter cap of the reusable, resterilizable half-mask shown in FIG. 1, viewing from different directions;

FIGS. 18 and 19 are perspective views of a neck mounting structure of the reusable, resterilizable half-mask shown in FIG. 1, viewing from different directions, wherein the neck mounting structure comprises a neck hook and a neck loop;

FIG. 20 is a side view of a portion of the proximal side of the neck hook shown in FIG. 18;

FIG. 21 is a perspective view of a strap band of the neck mounting structure shown in FIG. 18;

FIG. 22 is a perspective view of a head mounting structure of the reusable, resterilizable half-mask shown in FIG. 1;

FIG. 23 is a perspective view of the head mounting structure shown in FIG. 22, showing a clip thereof;

FIGS. 24 to 27 are perspective views showing assembling of the reusable, resterilizable half-mask shown in FIG. 1, wherein

FIG. 24 shows attaching the strap harnesses shown in FIG. 13 onto the mask body shown in FIG. 10A,

FIG. 25 shows attaching the filter caps shown in FIG. 16 onto the mask body shown in FIG. 10A,

FIG. 26 shows attaching the head mounting structure shown in FIG. 22 onto the strap harnesses shown in FIG. 13, and

FIG. 27 is an enlarged view of portion A of the reusable, resterilizable half-mask shown in FIG. 26;

FIG. 28 is a perspective view of the mask body of the reusable, resterilizable half-mask shown in FIG. 1, according to some embodiments of the present disclosure;

FIG. 29 is a perspective view of the mask body of the reusable, resterilizable half-mask shown in FIG. 1, according to yet some embodiments of the present disclosure;

FIGS. 30 and 31 are perspective views of the filter cap of the reusable, resterilizable half-mask shown in FIG. 1, according to still some embodiments of the present disclosure;

FIG. 32 is a perspective view of a face shield of the reusable, resterilizable half-mask shown in FIG. 1, according to some embodiments of the present disclosure;

FIG. 33 is a perspective view showing the reusable, resterilizable half-mask shown in FIG. 1 with the face shield shown in FIG. 32 secured thereon;

FIG. 34 is a schematic diagram of a respirator tracking system, according to some embodiments of the present disclosure;

FIG. 35 is a schematic diagram showing a simplified hardware structure of a computing device of the respirator tracking system shown in FIG. 34; and

FIG. 36 a schematic diagram showing a simplified software architecture of a computing device of the respirator tracking system shown in FIG. 34.

### DETAILED DESCRIPTION

Embodiments disclosed herein relate to reusable, recleanable, resterilizable respirator apparatus which in some embodiments, may be in the form of a half-mask. After each use, the respirator apparatus may be cleaned, sterilized, sanitized, and/or disinfected for reuse. The term “sanitizing” or “sanitization” may sometimes refer to removing and/or killing bacterial, and the term “disinfecting” or “disinfection” may be used interchangeably and refer to a process of removing and/or killing bacterial and viruses on or in the respirator apparatus, and/or reconditioning the respirator apparatus to a useable state with reduced risks.

According to one aspect of this disclosure, a reusable, resterilizable respirator apparatus may comprise: a mask body, the mask body comprising at least one filter chamber for receiving therein at least one filter cartridge, the at least one filter chamber comprising at least one chamber sidewall extending outwardly from the mask body; at least one strap harness demountably attachable to the chamber sidewall, the at least one strap harness comprising a plurality of fastening anchors for coupling to one or more mounting structures; and at least one filter cap demountably attachable to the at least one chamber sidewall for securing the at least one filter cartridge in the at least one filter chamber and for securing the at least strap harness on the at least one chamber sidewall.

According to one aspect of this disclosure, a reusable, resterilizable respirator apparatus may be provided with a Radio-frequency identification (RFID) chip attached thereto or encased therein or inserted therein to enable monitoring the location of the respirator apparatus, determining if the respirator apparatus is being worn by a user, detecting and recording a cleaning event and/or a disinfection event and/or a sterilization event, determining a change in a temperature of the respirator apparatus while it is being worn by a user, and transmitting the location and records to a data receiver or monitor. Such reusable, resterilizable respirator apparatus that are outfitted with RFID chips or alternatively are configured to receive therein RFID chips, may be referred to as reusable, resterilizable smart respirator apparatus or as reusable, resterilizable smart half-mask respirator apparatus.

The reusable, resterilizable respirator apparatus and systems disclosed herein are particularly suitable for use by individuals working in healthcare environments or in workplace environments.

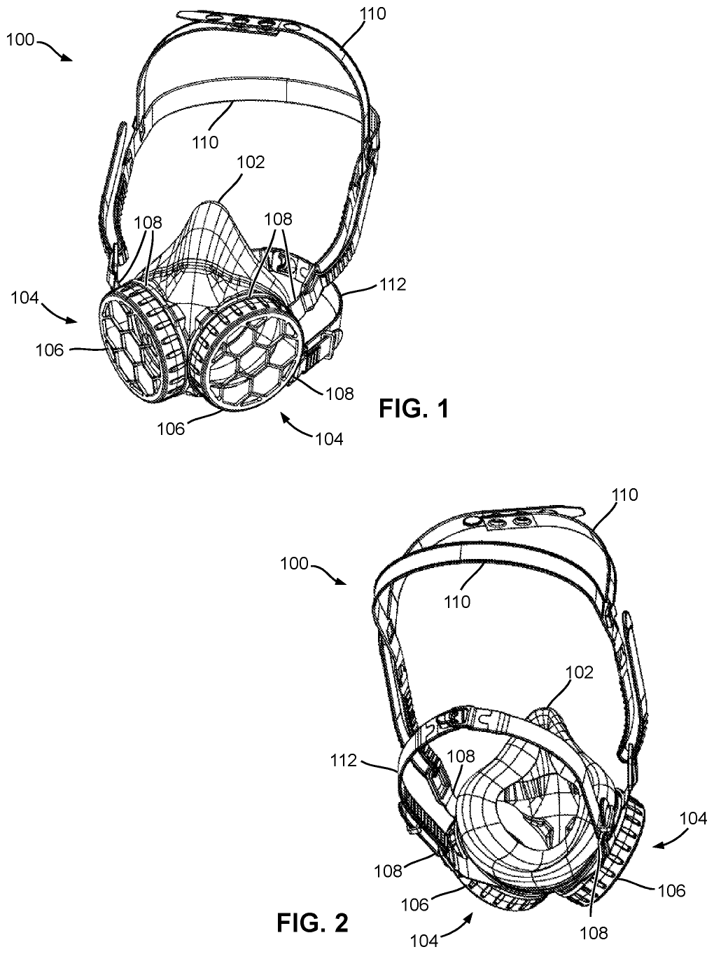

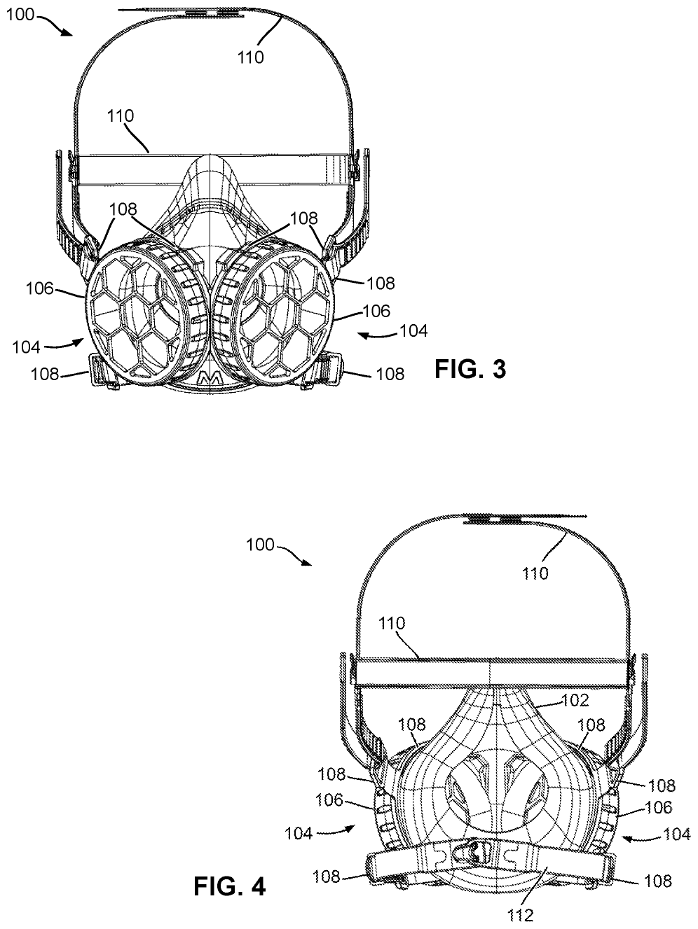

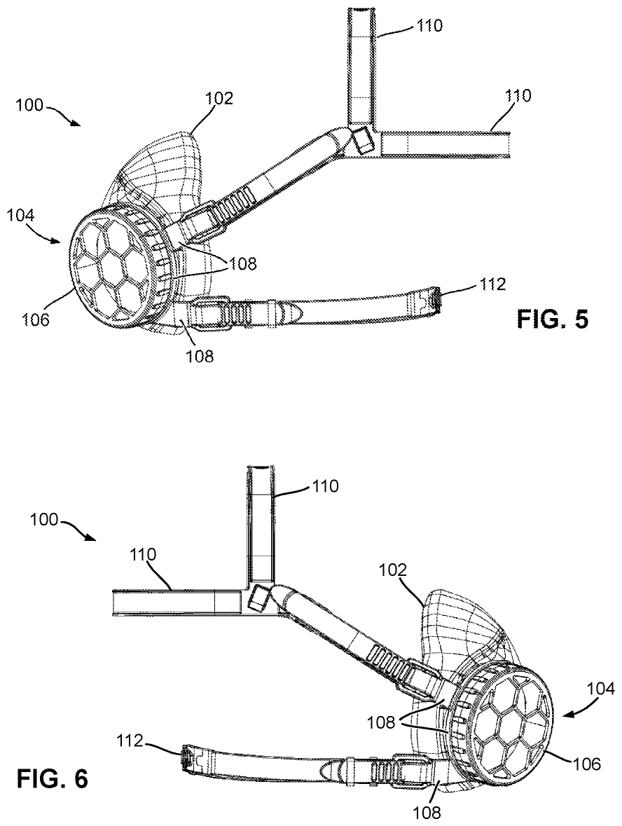

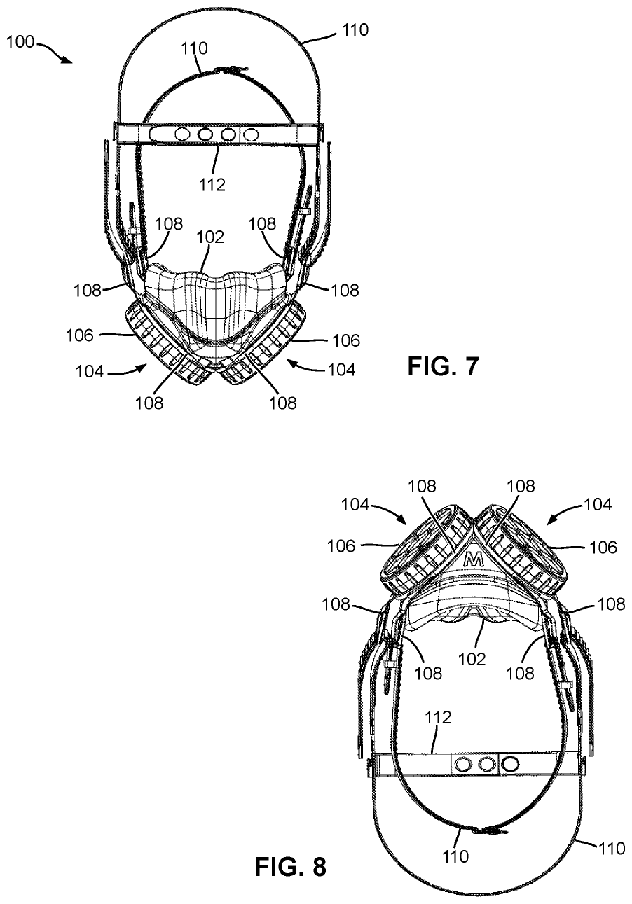

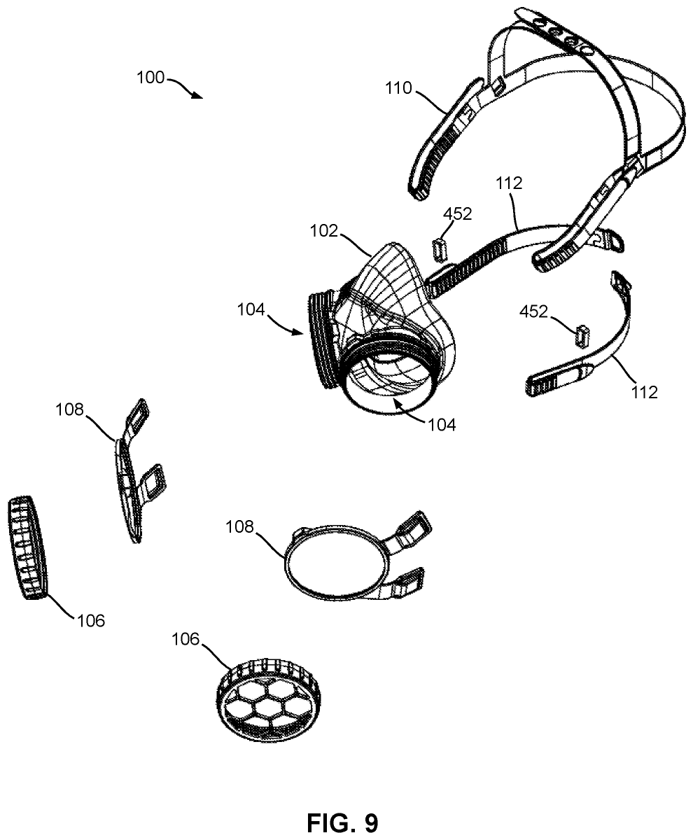

Turning to FIGS. 1 to 9, a reusable, resterilizable respirator apparatus in some embodiments is shown and is generally identified using reference numeral 100. In these embodiments, the reusable, resterilizable respirator apparatus 100 is in the form of a half-mask and comprises a mask body 102 having one or more filter chambers 104 each receiving therein one or more filter cartridges (not shown) and enclosed by a filter cap 106, one or more strap harnesses 108 demountably attached to or otherwise demountably coupled to the filter chambers 104 and locked between the mask body 102 and the filter caps 106, a head mounting strap structure 110 (also denoted a “head halo”), and a neck mounting structure 112.

In these embodiments, the mask body 102, the one or more strap harnesses 108, the head mounting strap structure 110, and the neck mounting structure 112 are reusable and resterilizable. The filter caps 106 and the filter cartridges are disposable.

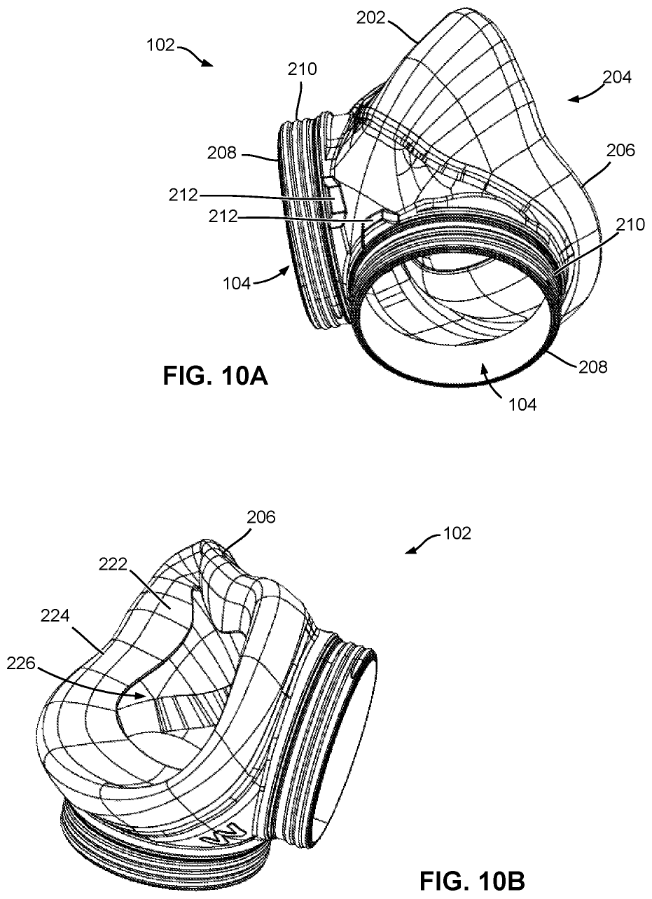

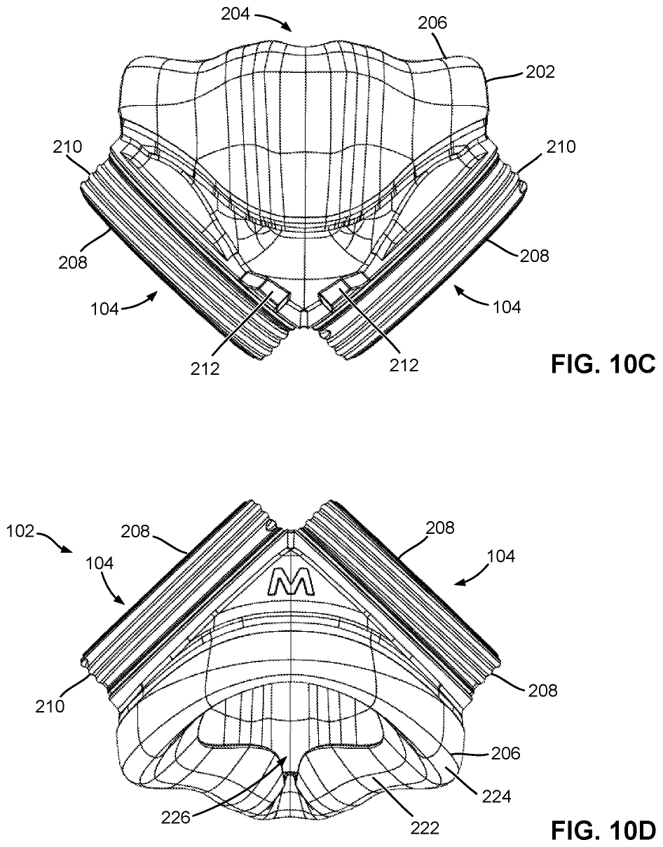

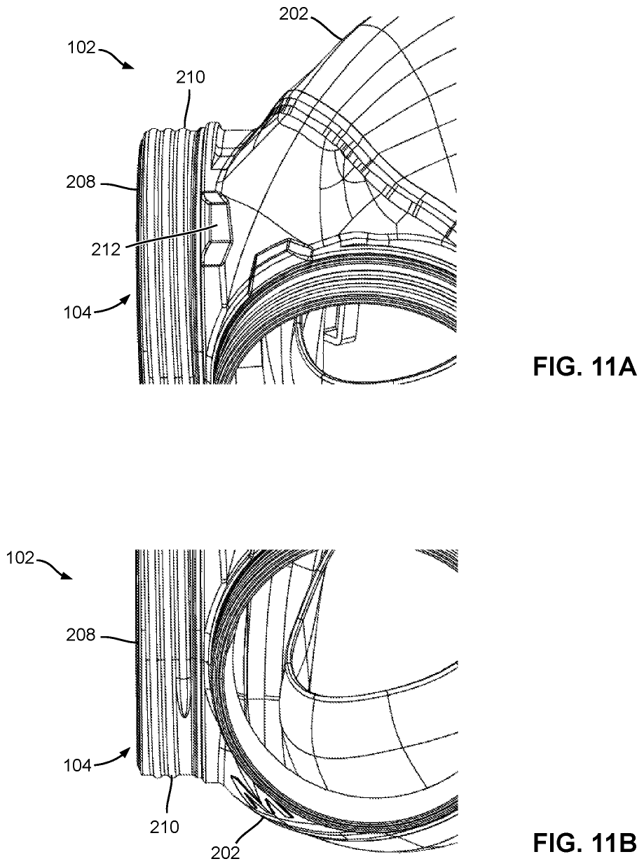

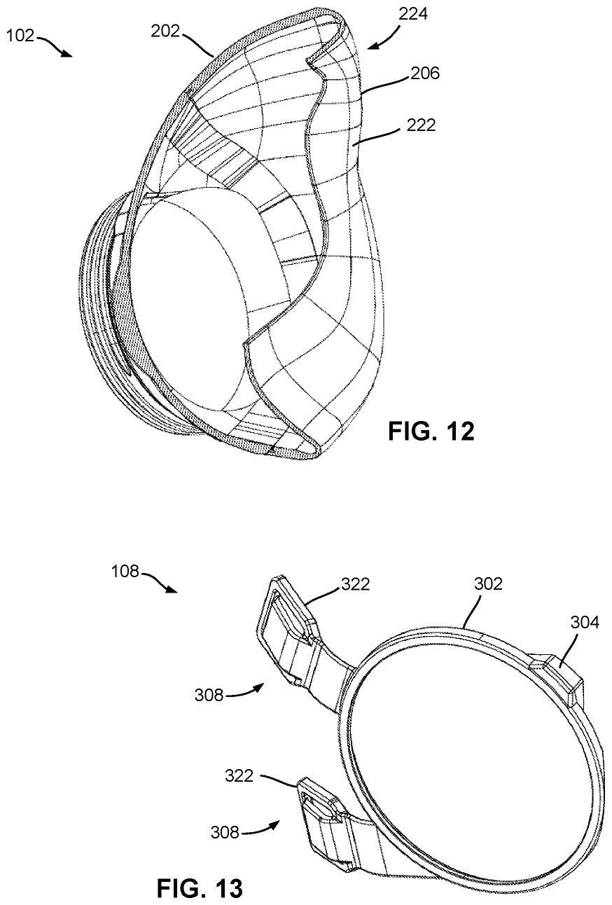

FIGS. 10A to 12 show the mask body 102. As shown, the mask body 102 comprises a front wall 202 in a cup-like shape for forming an inner space 204 for receiving a user's face. In these embodiments, the front wall 202 has a smooth, convex profile (with respect to the user's face), that is, generally extending forwardly from the edge 206 towards the center thereof. The edge 206 of the front wall 202 has a suitable contour for substantively adapting to the profile of the user's face including the nose area thereof, for facilitating an air-tight sealing against the user's face when use.

The mask body 102 comprises one or more chamber sidewalls 208 such as one or more cylindrical chamber sidewalls extending outwardly from the front wall 202, thereby forming one or more filter chambers 104 for receiving therein one or more filter cartridges (not shown). Herein, the filter cartridges comprise a suitable filtering material in a suitable structure for filtering particles of predefined sizes such as particles of sizes greater than 0.1 μm as required by the N-95 standard. The filter cartridges generally has a shape and size matching that of the chambers 104 such that the filter cartridges may be air-tightly received in the chambers 104 to ensure that the inflow air may pass through the chambers 104 only via the filter cartridges.

In these embodiments, each chamber sidewall 208 comprises a sealing edge and a plurality of threads 210 on the outer surface thereof. Each chamber sidewall 208 also comprises a delimit protrusion 212 on the outer surface thereof at the interface between the chamber sidewall 208 and the front wall 202. The threads 210 have a shallow profile with no sharp edges/valleys (for example, any concave or recessed section of the threads 210 has a smoothly curved contour and with an obtuse angle (for example, measured between two tangential lines thereof)) for ease of cleaning and sanitization.

In these embodiments, the delimit protrusion 212 has a shape such as a frustum shape suitable for sterilization using a wiper.

In these embodiments, a substantively central portion of the front wall 202 is made of a rigid material such as polypropylene for supporting the filter chambers 104 and the filter cartridges received therein. A peripheral portion of the front wall 202 is made of a flexible material such as soft thermoplastic elastomers (TPE) for adapting to the rear wall 222 (described later) for facilitating the rear wall 222 to adapt to the profile of the user's face for forming an air-tight seal.

The mask body 102 also comprises a rear wall 222 extending from the edge 206 of the front wall 202 forwardly into the inner space 204. In these embodiments, the rear wall 222 is made of the same flexible material as the peripheral portion of the front wall 202 and integrated therewith via a smoothly curved flexible transition 224. The rear wall 222 comprises a central opening 226 in communication with the one or more filter chambers 104.

Those skilled in the art will appreciate that in some alternative embodiments, the rear wall 222 may be made of a different flexible material and/or a flexible material of different properties than those of the peripheral portion of the front wall 202 and may be attached to or otherwise coupled to the front wall 202 via the smoothly curved transition 224.

Thus, as shown in FIGS. 10A to 12, each of the front wall 202 and the rear wall 222 has a substantially smooth contour and the transition 224 between the front wall 202 and the rear wall 222 is also smoothly curved, thereby making the front wall 202, the rear wall 222, and the transition 224 suitable and easy to clean and sterilize, for example, using a wiper. The design that the peripheral portion of the front wall 202, the rear wall 222, and the transition 224 are flexible further makes these parts suitable and easy to clean and sterilize, for example, using a wiper.

The central portion of the front wall 202 is smoothly transition from the flexible peripheral portion of the front wall 202 and the contour thereof generally does not comprise any narrow or sharp-angled concave or recessing sections. In other words, any concave or recessed section of the mask body 102 has a smoothly curved contour or has an obtuse angle (for example, measured between two tangential lines thereof), and may have a sufficiently large size to allow, for example, a finger to position therein for using a wipe to clean and sterilize the concave or recessing section.

In some embodiments, the reusable parts of the half-mask 100, such as the mask body 102, the one or more strap harnesses 108, the head mounting strap structure 110, and the neck mounting structure 112, generally do not comprise any narrow or sharp-angled concave or recessing sections. In other words, any concave or recessed section of the reusable parts of the half-mask 100 has a smoothly curved contour or has an obtuse angle (for example, measured between two tangential lines thereof). In some embodiments, any concave or recessed section of the reusable parts of the half-mask 100 may further have a sufficiently large size to allow, for example, a human finger to position therein for using a wipe to clean and sterilize the concave or recessing section.

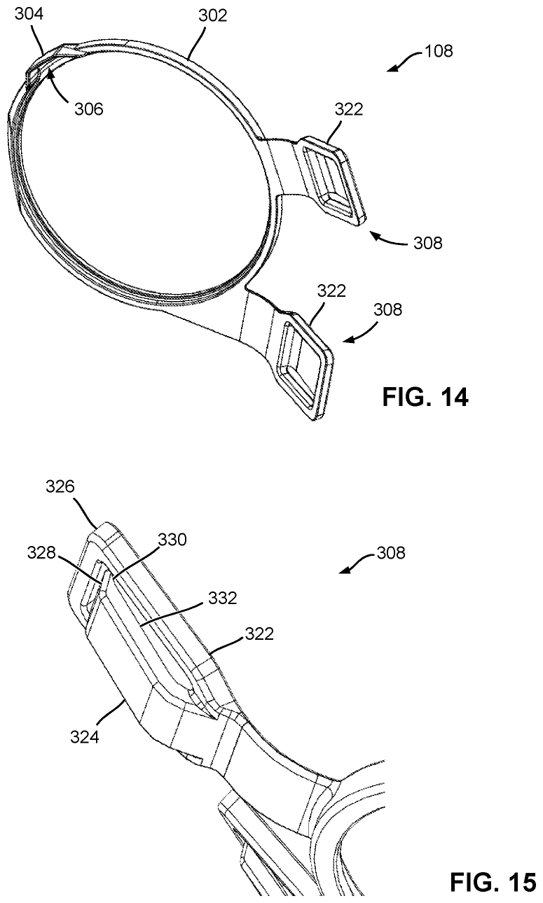

FIGS. 13 and 14 show the strap harness 108. As shown, the strap harness 108 comprises a ring-shape body 302 demountably attachable to the chamber sidewall 208 of the mask body 102, and a delimiter or delimit protrusion 304 radially outwardly extending from the ring-shape body 302. The delimiter 304 comprises a rearwardly and radially inwardly facing recess 306 for coupling to the delimit protrusion 212 on the outer surface of the chamber sidewall 208 of the mask body 102.

The radially inwardly facing recess 306 has a shape substantially corresponding to that of the delimit protrusion 212 of the mask body 102. In these embodiments, the radially inwardly facing recess 306 has a shape such as a frustum shape suitable for sterilization using a wiper.

In these embodiments, the strap harness 108 also comprises one or more fastening structures 308 coupled to or integrated with the ring-shape body 302 for coupling the head mounting strap structure 110 and/or the neck mounting structure 112 to the strap harness 108. As shown in FIG. 15, each fastening structure 308 comprises a fastening anchor 322 in the form of a fastening loop such as a rectangular-shaped fastening loop and a tab 324 on the front side of the fastening loop 322 extending from a location at a distance from the distal end 326 of the fastening loop 322 to a position adjacent the distal end 326. The tab 324 comprises a wedge-shaped distal portion 328 at an obtuse angle to the rest of the tab 324, and is flexible towards or away from the fastening loop 322 under a force greater than a predefined threshold. In some embodiments, the obtuse angle, measured at the rear surface 330 of the wedge-shaped distal portion 328 is about 160° to the rear surface 332 of the rest of the tab 324.

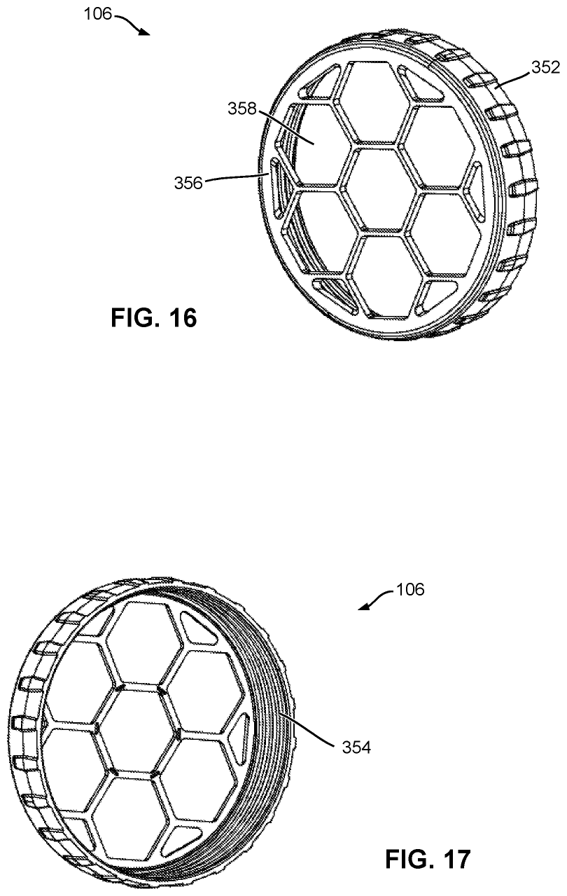

The filter cap 106 is shown in FIGS. 16 and 17. In these embodiments, the filter cap 106 is disposable and comprises a sidewall 352 with textured outer surface for user to hold and turn, and a plurality of threads 354 on the inner surface of the sidewall 352 for engaging the threads 210 of the chamber sidewall 208 to secure the filter cartridge in the chamber 104. The filter cap 106 also comprises an end wall 356 with one or more openings 358 forming a mesh for allowing air to pass through and into the filter cartridge therebehind. Of course, those skilled in the art will appreciate that, in some other embodiments, filter cap 106 may not contain the mesh structure, and rather contains a circular opening to expose the filter cartridge directly.

In these embodiments, the filter cap 106 comprises a mark (not shown) for indicating the filter cap 106 being properly secured to the chamber sidewall 208 when the mark is aligned with a corresponding mark on the mask body 102 and/or the strap harness 108 adjacent the chamber sidewall 208. Such as mark may be a texture on the outer surface of the sidewall the filter cap 106 with a special shape, color, size, protrusion, recess, and/or the like. The mark on the mask body 102 may a texture on the outer surface of the sidewall the filter cap 106 with a special shape, color, size, protrusion, recess, and/or the like, on a predefined location, for example, on the protrusion 304 of the strap harness 108.

The filter cartridge (for example, a circular disposable filter media puck) may be directly dropped into the filter chamber 104 prior to the filter cap 106 threading onto the chamber sidewall 208, where a sealing ring pinches and compresses the filter cartridge thereby creating an air-tight seal radially around the circumference of the filter cartridge which may be particularly useful for N-95 filter cartridges. Alternatively, the filter cartridge may be ultrasonically welded to the inside of the filter cap 106 around the circumference of the filter cartridge, thus creating a one-piece disposable filter cartridge for improved ease of assembly and convenience.

In some embodiments, the threads 354 of the filter cap 106 and the corresponding threads 210 of the chamber sidewall 208 allow a hard stop when the filter cap 106 is properly secured to the chamber sidewall 208. Such a hard stop may be an indication to the user indicating proper securing of the filter cap 106.

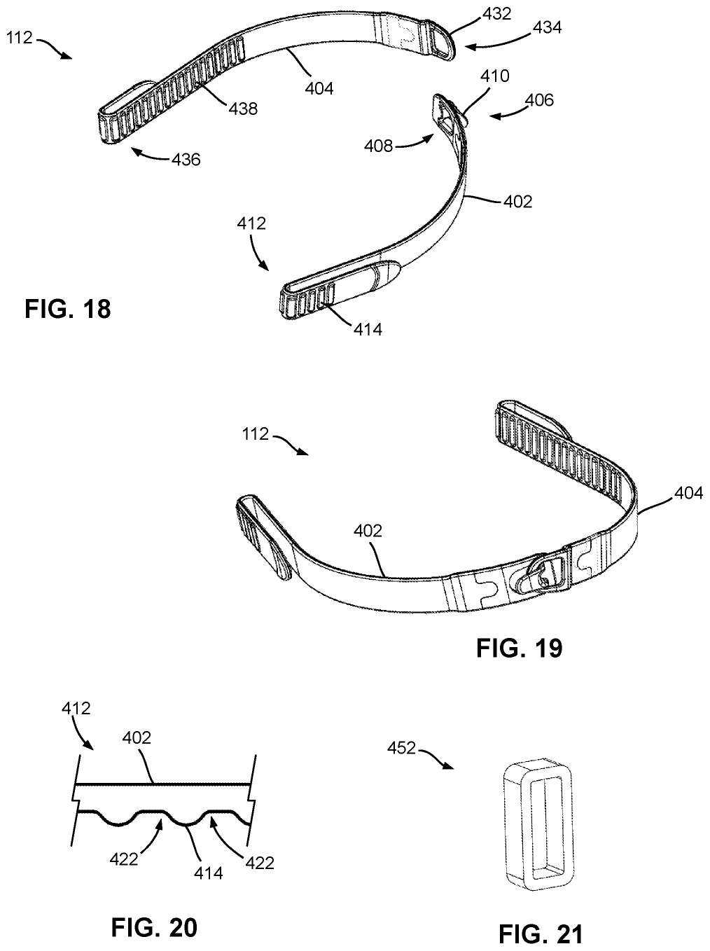

FIGS. 18 and 19 show the neck mounting structure 112 which comprises a neck hook 402 and a neck loop 404. The neck hook 402 comprises a hook structure 406 on the distal end 408 thereof formed by a tab 410 on the outer side of the neck hook 402 and extending towards the proximal side 412 thereof. The proximal side 412 of the neck hook 402 comprises a plurality of parallel protrusions 414 extending laterally and generally perpendicular to a longitudinal axis of the neck hook 402.

The hook structure 406 may be made of a suitable rigid plastic material such as polypropylene. The proximal side 412 of the neck hook 402 is made of an elastomeric material. The neck hook 402 also comprises a transition region between the distal end 408 and the proximal side 412.

As shown in FIG. 20, each protrusion 414 generally has a semi-cylindrical shape thereby forming an obtuse angle 422 with respect to the body of the neck hook 402 on both sides thereof.

Referring again to FIGS. 18 and 19, the neck loop 404 comprises a loop structure 432 on the distal end 434 thereof. The proximal side 436 of the neck loop 404 comprises a plurality of parallel protrusions 438 extending laterally and generally perpendicular to a longitudinal axis of the neck loop 404. The protrusions 438 are similar to the protrusions 414 of the neck hook 402, that is, each generally having a semi-cylindrical shape thereby forming an obtuse angle with respect to the body of the neck loop 404 on both sides thereof.

The loop structure 432 is made of a suitable rigid plastic material such as polypropylene. The proximal side 436 of the neck loop 404 is made of an elastomeric material. The neck loop 404 also comprises a transition region between the distal end 434 and the proximal side 436.

As shown in FIG. 21, the neck mounting structure 112 may also comprise a pair of strap band 452 for attaching the proximal ends 412 and 436 of the neck hook 402 and the neck loop 404 against or in proximity with the bodies thereof, when wrapping through the respective fastening loops 322 of the strap harnesses 108.

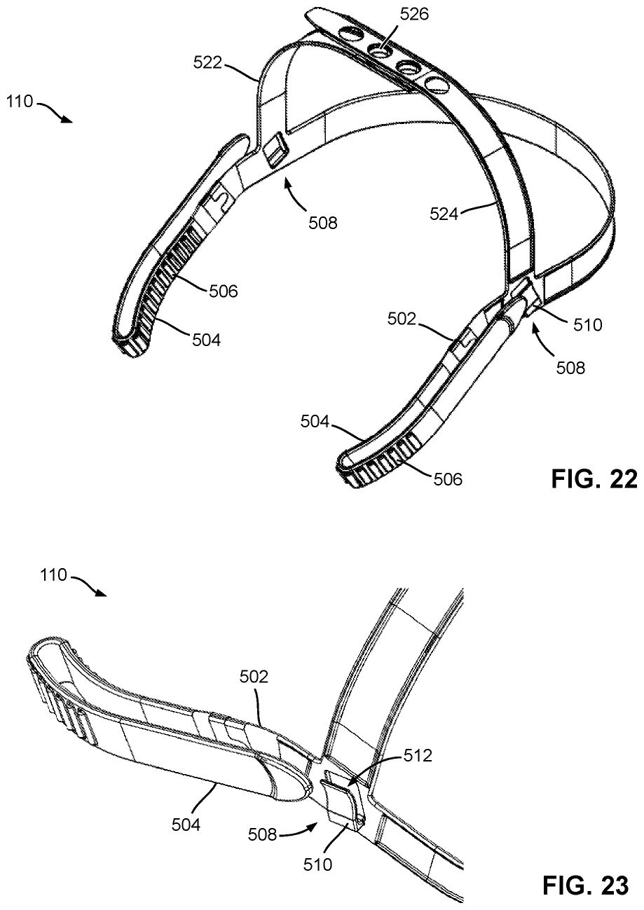

FIG. 22 shows the head mounting structure 110. As shown, the head mounting structure 110 comprises a horizontal strap 502 having two opposite end portions 504 each of which comprises a plurality of parallel protrusions 506 extending laterally and generally perpendicular to a longitudinal axis of the horizontal strap 502. The protrusions 506 are similar to the protrusions 414 of the neck hook 402, that is, each generally having a semi-cylindrical shape thereby forming an obtuse angle with respect to the body of the horizontal strap 502 on both sides thereof.

The end portions 504 of the horizontal strap 502 may be made of an elastomeric material while an intermediate portion therebetween may be made of a suitable rigid plastic material such as polypropylene and coupled to the end portions via respective transition regions.

Also shown in FIG. 23, the horizontal strap 502 comprises a pair of clips 508 adjacent respective end portions 504. Each clip 508 comprises a tab 510 on the outer side thereof with a generally upward-facing gap 512 between the tab 510 and the body of the horizontal strap 502 for easily attaching the respective end portion 504 of the horizontal strap 502 against or in proximity with the body thereof, when wrapping through the respective fastening loops 322 of the strap harnesses 108.

Referring again to FIG. 22, the head mounting structure 110 also comprises a pair of vertical straps 522 and 524 vertically extending from suitable positions of the horizontal strap 502 corresponding to opposite sides of the user's head. The vertical strap 522 comprises a plurality of protrusions (not shown) along a longitudinal direction and preferably with uniform spacing therebetween. The vertical strap 524 comprises a plurality of holes 526 for receiving and snap-fitting the protrusions of the vertical strap 522 to engage the vertical straps 522 and 524 and form a band over the user's head. The user may adjust the length of the band by aligning the protrusions of the vertical strap 522 with different holes 526 of the vertical strap 524 and inserting the protrusions into the holes 526.

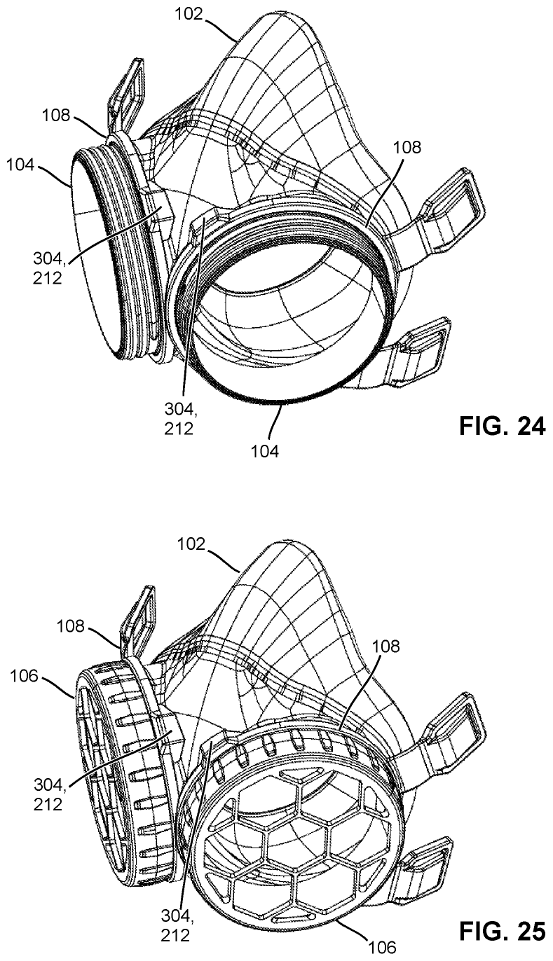

As shown in FIG. 24, to assemble the half-mask 100, one may attach the strap harnesses 108 about the chamber sidewalls 208 of respective filter chambers 104 against the mask body 102 at a suitable angle such that the radially inwardly facing recess 306 of the delimiter 304 of each strap harness 108 receives the respective delimit protrusion 212 of the mask body 102.

Then, one or more filter cartridges (not shown) are inserted into the filter chambers 104. As shown in FIG. 25, the filter caps 106 are attached to the chamber sidewalls 208 of the filter chambers 104 to secure the filter cartridges therein.

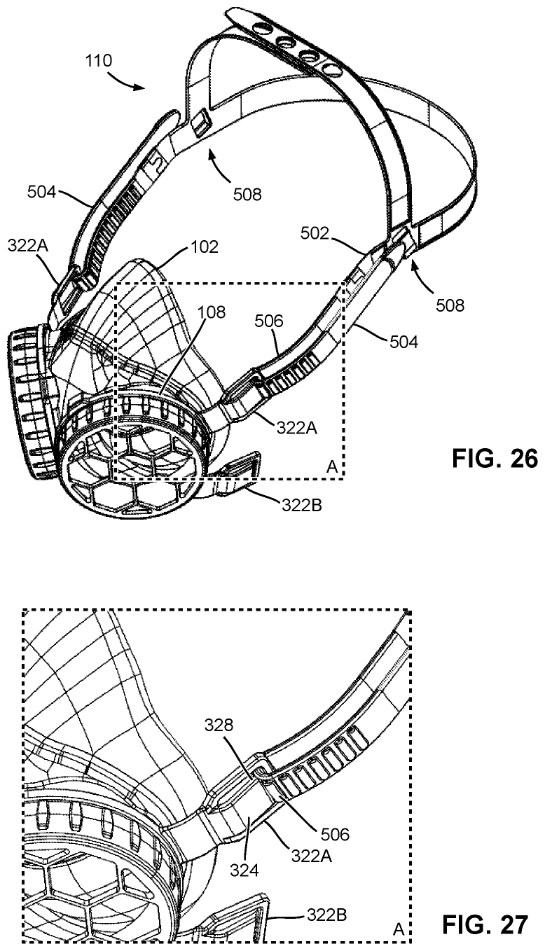

As shown in FIGS. 26 and 27, one may wrap each end portion 504 of the horizontal strap 502 through a respective upper fastening loop 322A. By applying a sufficient force, the protrusions 506 of the horizontal strap 502 actuate the wedge-shaped distal portion 328 of the tab 324 to force the tab 324 to flex and allow the protrusions 506 to move through for adjusting the horizontal strap 502 for fitting to the user's head. After adjustment, the wedge-shaped distal portion 328 of the tab 324 is positioned between two adjacent protrusions 506. The user may then snap the ends of the horizontal strap 502 into the clips 508.

The user may attach the neck hook 402 and the neck loop 404 to respective lower fastening loops 322B in a similar manner and couple the neck hook 402 and the neck loop 404 together. The assembled half-mask 100 is shown in FIG. 1.

The half-mask 100 disclosed herein is generally reusable while the filter cartridges and the filter caps 106 may be disposed after a predefined period of use and may be replaced with new filter cartridges and new filter caps 106. After each use, the reusable components of the half-mask 100, such as the mask body 102, the strap harnesses 108, the head mounting structure 110, and the neck mounting structure 112, may be disassembled and separately sterilized or sanitized, e.g., by using a sterilizing wiper to wipe the surfaces of each component 102, 108, 110 and 112.

The reusable components of the half-mask 100, such as the mask body 102, the strap harnesses 108, the head mounting structure 110, and the neck mounting structure 112, do not comprise any sharp or narrow recesses or recessing corners that may otherwise be difficult to reach and sterilize using a wiper. For example, by using a demountable strap harness 108, the half-mask 100 disclosed herein eliminates the sharp recessing interface between the strap harness 108 and the mask body 102 (when disassembled and sterilized) otherwise often seen in many prior-art masks with integrated strap harness on the mask body. As another example, the threads 210 on the outer surface of the chamber sidewalls 208 have a shallow profile with no sharp edges which also facilitates ease and thoroughness of cleaning and sterilization.

The fastening loop 322 of the strap harness 108 with the tab 324 that has a wedge-shaped distal portion 328, together with the protrusions 506 and 438 of the head mounting structure 110 and the neck mounting structure 112 allow the user to easily adjust the tightness of the half-mask 100 on the user's head.

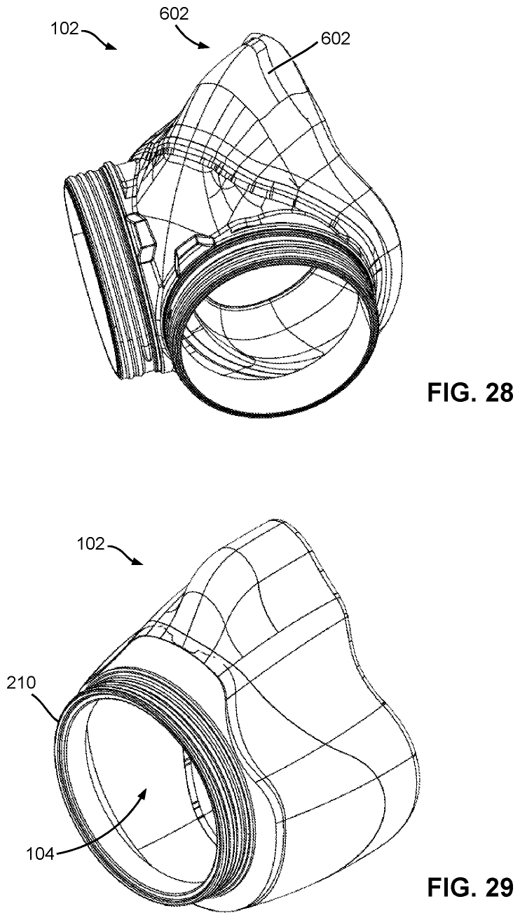

Those skilled in the art will appreciate that other embodiments are readily available. For example, FIG. 28 shows a mask body 102 in some embodiments. The mask body 102 is similar to that shown in FIG. 10A except that the mask body 102 in these embodiments comprises a pair of concave areas 602 (that is, extending rearwardly from the peripheral of the area 602 towards the center thereof) about the opposite sides of a user's nose.

FIG. 29 shows a mask body 102 in some other embodiments. The mask body 102 is similar to that shown in FIG. 10A except that the mask body 102 in these embodiments comprises a single filter chamber 104 defined by a single chamber sidewall 208.

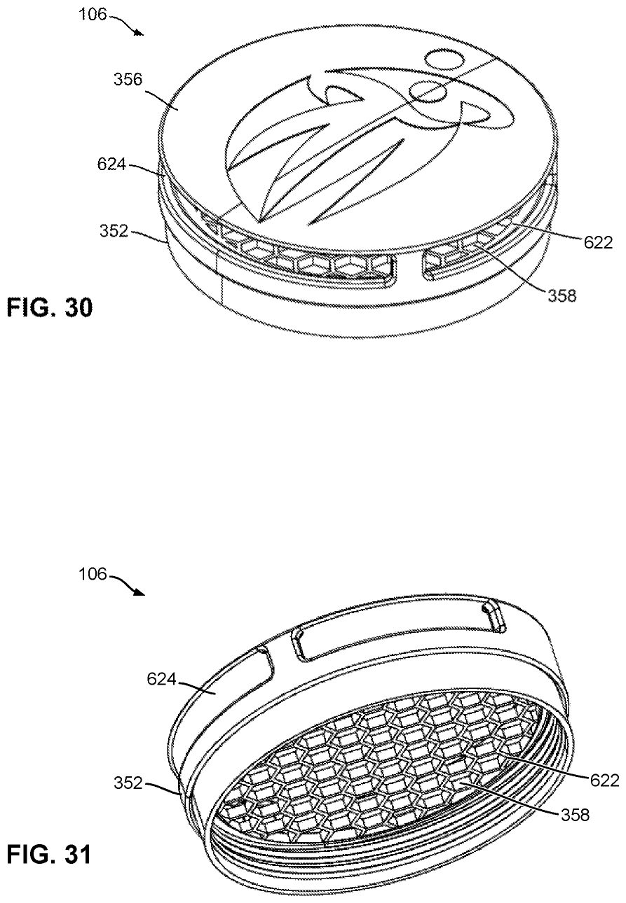

FIGS. 30 and 31 show a filter cap 106 in some alternative embodiments. As shown, the filter cap 106 in these embodiments comprises a solid end wall 356, a separate mesh layer 622 having a plurality of openings 358, and one or more openings 624 on the sidewall 352 thereof at locations intermediate the solid end wall 356 and the mesh layer 622.

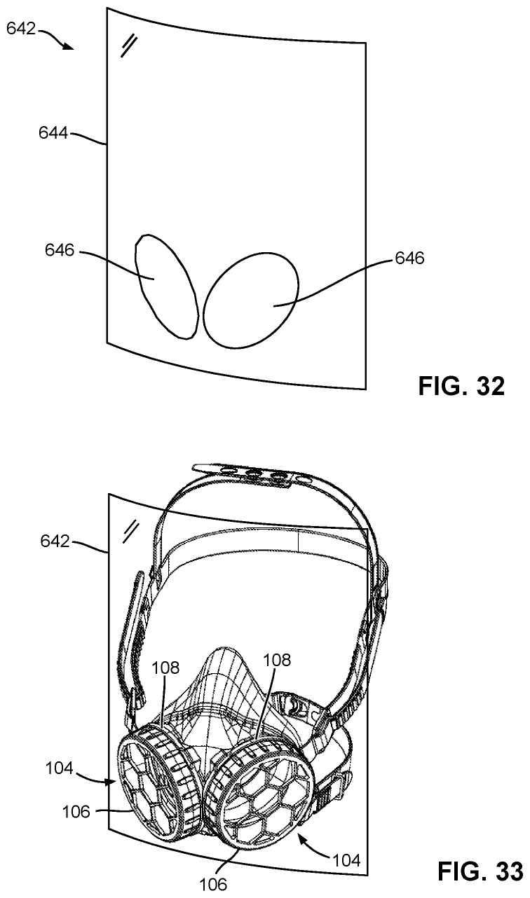

In some embodiments, the half-mask 100 may further comprise a face shield 642 attachable to the mask body 102 shown in FIG. 10A for further protection. As shown in FIG. 32, the face shield 642 comprises a sheet 644 shaped in a suitable curvature with two mounting holes 646 thereon at positions corresponding to the chamber sidewalls 208. At least a portion of the sheet 644 about the location of a user's eyes comprises a transparent or semi-transparent material.

To attach the face shield 642 to the half-mask 100, one may detach the filter cap 106 and the strap harnesses 108 from the mask body 102, and attach the face shield 642 onto the chamber sidewalls 208 against the mask body 102. Then, one may attach the strap harnesses 108 to the chamber sidewalls 208 against the face shield 642, and thread the filter cap 106 onto the chamber sidewalls 208 to secure the strap harnesses 108 and the face shield 642 in place, as shown in FIG. 33.

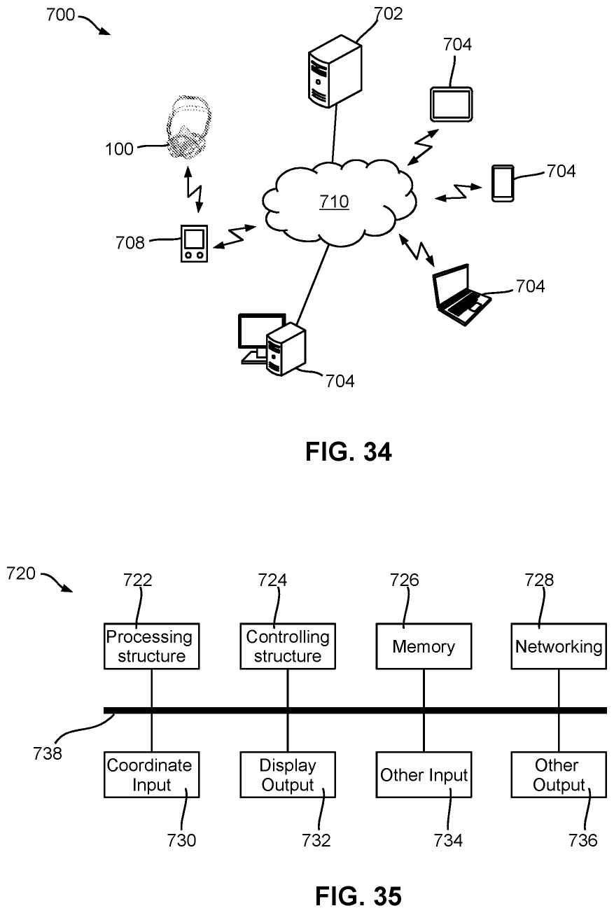

FIG. 34 shows a respirator tracking system 700 in some embodiments. As shown, the respirator tracking system 700 comprises a server computer 702, a plurality of client computing devices 704, one or more respirator apparatuses 100 such as one or more half-masks described herein with health monitoring functions, and one or more sensing devices 708, functionally interconnected by a network 710, such as the Internet, a local area network (LAN), a wide area network (WAN), a metropolitan area network (MAN), a cloud-based network, and/or the like via suitable wired and wireless networking connections.

The sensing devices 708 may be one or more specialized sensing or communication devices such as one or more radio-frequency identification (RFID) scanners. The sensing devices 708 may alternatively or also be one or more general-purpose devices with necessary sensing functionalities such as one or more smartphones with RFID scanning functionality.

Each half-mask 100 may comprise one or more suitable communication components such as one or more automatic-identification-and-data-capture (AIDC) sensors. For example, in these embodiments, each half-mask 100 may comprise a suitable RFID tag such as the RF XXS02 AC Tag offered by RadioForce GmbH of Attenkirchen, GERMANY, embedded therein. The sensing device 708 comprises necessary circuits for detecting the RFID tag of the half-mask 100 and communicate with the server computer 702 for tracking the usage of the half-masks 100 and/or inventory management of the half-masks 100.

The server computer 702 executes one or more server programs. Depending on implementation, the server computer 702 may be a server-computing device, and/or a general purpose computing device acting as a server computer while also being used by a user.

Each client computing device 704 executes one or more client application programs (or so-called “apps”) and for users to use. The client computing devices 704 may be portable computing devices such as laptop computers, tablets, smartphones, Personal Digital Assistants (PDAs), and the like. However, those skilled in the art will appreciate that one or more client computing devices 704 may be non-portable computing devices such as desktop computers in some alternative embodiments.

Generally, the computing devices 702 and 704 have a similar hardware structure such as a hardware structure 720 shown in FIG. 35. As shown, the computing device 702/704 comprises one or more processing structures or processors 722, a controlling structure 724, one or more non-transitory computer-readable memory or storage devices 726, a networking interface 728, coordinate input 730, display output 732, and other input and output modules 734 and 736, all functionally interconnected by a system bus 738.

The processing structure 722 may be one or more single-core or multiple-core computing processors such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, or the like.

The controlling structure 724 comprises one or more controlling circuits, such as graphic controllers, input/output chipsets and the like, for coordinating operations of various hardware components and modules of the computing device 702/704.

The memory 726 comprises a plurality of memory units accessible by the processing structure 722 and the controlling structure 724 for reading and/or storing instructions for the processing structure 222 to execute, and for reading and/or storing data, including input data and data generated by the processing structure 722 and the controlling structure 724. The memory 726 may be volatile and/or non-volatile, non-removable or removable memory such as RAM, ROM, EEPROM, solid-state memory, hard disks, CD, DVD, flash memory, or the like. In use, the memory 726 is generally divided to a plurality of portions for different use purposes. For example, a portion of the memory 726 (denoted as storage memory herein) may be used for long-term data storing, for example, for storing files or databases. Another portion of the memory 726 may be used as the system memory for storing data during processing (denoted as working memory herein).

The networking interface 728 comprises one or more networking modules for connecting to other computing devices or networks through the network 710 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), ZIGBEE® (ZIGBEE is a registered trademark of ZigBee Alliance Corp., San Ramon, CA, USA), 3G, 4G and/or 5G wireless mobile telecommunications technologies, and/or the like. In some embodiments, parallel ports, serial ports, USB connections, optical connections, or the like may also be used for connecting other computing devices or networks although they are usually considered as input/output interfaces for connecting input/output devices.

The display output 732 comprises one or more display modules for displaying images, such as monitors, LCD displays, LED displays, projectors, and the like. The display output 732 may be a physically integrated part of the computing device 702/704 (for example, the display of a laptop computer or tablet), or may be a display device physically separate from but functionally coupled to other components of the computing device 702/704 (for example, the monitor of a desktop computer).

The coordinate input 730 comprises one or more input modules for one or more users to input coordinate data, such as touch-sensitive screen, touch-sensitive whiteboard, trackball, computer mouse, touch-pad, or other human interface devices (HID) and the like. The coordinate input 730 may be a physically integrated part of the computing device 702/704 (for example, the touch-pad of a laptop computer or the touch-sensitive screen of a tablet), or may be a device physically separate from, but functionally coupled to, other components of the computing device 702/704 (for example, a computer mouse). The coordinate input 730, in some implementation, may be integrated with the display output 732 to form a touch-sensitive screen or touch-sensitive whiteboard.

The computing device 702/704 may also comprise other input 734 such as keyboards, microphones, scanners, cameras, Global Positioning System (GPS) component, and/or the like. The computing device 702/704 may further comprise other output 736 such as speakers, printers and/or the like.

The system bus 738 interconnects various components 722 to 736 enabling them to transmit and receive data and control signals to and from each other.

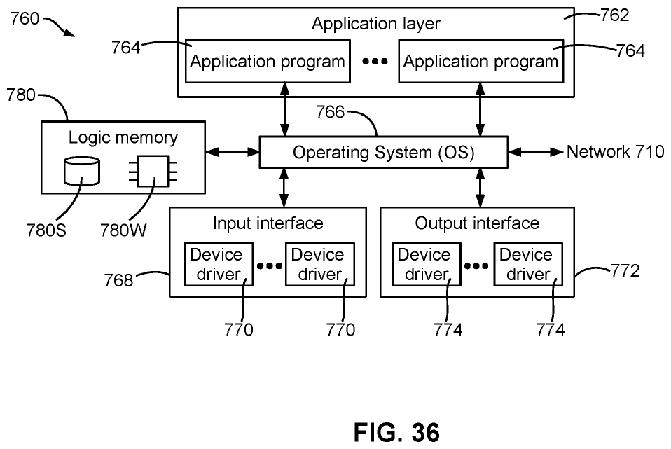

FIG. 36 shows a simplified software architecture 760 of the computing device 702 or 704. The software architecture 760 comprises an application layer 762, an operating system 766, an input interface 768, an output interface 772, and a logic memory 780. The application layer 762, operating system 766, input interface 768, and output interface 772 are generally implemented as computer-executable instructions or code in the form of software code or firmware code stored in the logic memory 780 which may be executed by the processing structure 722.

The application layer 762 comprises one or more application programs 764 executed by or run by the processing structure 722 for performing various tasks. The operating system 766 manages various hardware components of the computing device 702 or 704 via the input interface 768 and the output interface 772, manages the logic memory 780, and manages and supports the application programs 764. The operating system 766 is also in communication with other computing devices (not shown) via the network 710 to allow application programs 764 to communicate with those running on other computing devices. As those skilled in the art will appreciate, the operating system 766 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google Inc., Mountain View, CA, USA), or the like. The computing devices 702 and 704 of the respirator tracking system 700 may all have the same operating system, or may have different operating systems.

The input interface 768 comprises one or more input device drivers 770 for communicating with respective input devices including the coordinate input 730. The output interface 772 comprises one or more output device drivers 774 managed by the operating system 766 for communicating with respective output devices including the display output 732. Input data received from the input devices via the input interface 768 is sent to the application layer 762, and is processed by one or more application programs 764. The output generated by the application programs 764 is sent to respective output devices via the output interface 772.

The logical memory 780 is a logical mapping of the physical memory 726 for facilitating the application programs 764 to access. In this embodiment, the logical memory 780 comprises a storage memory area (780S) that may be mapped to a non-volatile physical memory such as hard disks, solid-state disks, flash drives, and the like, generally for long-term data storage therein. The logical memory 780 also comprises a working memory area (780W) that is generally mapped to high-speed, and in some implementations volatile, physical memory such as RAM, generally for application programs 764 to temporarily store data during program execution. For example, an application program 764 may load data from the storage memory area 780S into the working memory area 780W, and may store data generated during its execution into the working memory area 780W. The application program 764 may also store some data into the storage memory area 780S as required or in response to a user's command.

In a server computer 702, the application layer 762 generally comprises one or more server-side application programs 764 which provide server functions for managing network communication with client computing devices 704 and facilitating collaboration between the server computer 702 and the client computing devices 704. Herein, the term “server” may refer to a server computer 702 from a hardware point of view or a logical server from a software point of view, depending on the context.

The server-side application programs 764 communicates with the one or more sensing devices 708 to collect the RFID data of the half-masks 100 for tracking the half-masks 100 as needed.

In some embodiments, the half-mask 100 may further comprise a temperature sensor such as a passive temperature sensor, e.g., the ST25TV02K or ST25TV512 sensor which are NFC/RFID tags offered by STMicroelectronics of Geneva, Switzerland.

In these embodiments, the server-side application programs 764 collect the temperature data and track the use conditions of the half-mask 100. For example, the half-mask 100 is in use if the temperature data collected therefrom is within the typical range of human body temperatures, and is not in use if the temperature data collected therefrom is not within the typical range of human body temperatures. The server-side application programs 764 may also use the temperature data to determine the health condition of the user (e.g., having a fever, and/or the like). In some embodiments, the server-side application programs 764 may also use the temperature data to determine that the half-mask 100 is in a specific reprocessing or reconditioning cycle in an environment of a specific temperature.

In some embodiments, one or more half-masks 100 may comprise a near-field communication (NFC) circuitry or device for communicating with 708 for allowing the system 700 to track the half-masks 100 and/or for inventory management of the half-masks 100. In these embodiments, the sensing devices 708 may be one or more specialized sensing devices such as one or more specialized NFC communication devices. The sensing devices 708 may alternatively or also be one or more general-purpose devices with necessary sensing functionalities such as one or more smartphones and/or laptops with NFC scanning functionality.

In some embodiments, one or more half-masks 100 may comprise other sensors such as one or more bio-sensors for detecting infectious agents from the air of the user's breath.

In some embodiments, the filter cap 106 may be integrated with the filter cartridge, or the filter cap 106 may comprises a cartridge housing for receiving therein suitable filtering materials. Such a combined filter cap/cartridge may be denoted a filter cap-cartridge assembly. In these embodiments, separate filter cartridges are not needed. When the half-mask 100 needs filter cartridge replacement, one may simply remove the filter cap-cartridge assemblies and thread new filter cap-cartridge assemblies onto respective chamber sidewalls 208.

Although embodiments have been described above with reference to the accompanying drawings, those of skill in the art will appreciate that variations and modifications may be made without departing from the scope thereof as defined by the appended claims.

1. A respirator apparatus comprising:
a reusable and resterilizable mask body, the mask body comprising a front wall with at least one filter chamber thereon for receiving therein at least one filter cartridge, each of the at least one filter chamber comprising a chamber sidewall extending outwardly from the front wall; and
at least one disposable filter cap demountably attachable to the chamber sidewall of a corresponding one of the at least one filter chamber for securing the at least one filter cartridge in the corresponding filter chamber;
wherein any concave section of the mask body comprises a smoothly curved contour or comprises an obtuse angle measured between two tangential lines thereof.

2. The respirator apparatus of claim 1, wherein any concave section of the mask body has a size allowing a human finger to position therein for using a wipe to clean and sterilize the concave section.

3. The respirator apparatus of claim 1, wherein the front wall of the mask body comprises:
a central portion comprising the at least one filter chamber; and
a peripheral portion extending from the central portion;
wherein the central portion comprises a rigid material; and
wherein the peripheral portion comprises a first flexible material.

4. The respirator apparatus of claim 3, wherein the rigid material comprises polypropylene; and/or wherein the first flexible material comprises soft thermoplastic elastomers (TPE).

5. (canceled)

6. The respirator apparatus of claim 1, wherein the mask body further comprises a rear wall extending rearwardly from the front wall, the rear wall comprising an opening in communication with the at least one filter chamber.

7. (canceled)

8. (canceled)

9. The respirator apparatus of claim 6, wherein the mask body further comprises a transition wall smoothly transitioning between the front and rear walls.

10. (canceled)

11. (canceled)

12. The respirator apparatus of claim 1, wherein the chamber sidewall of each of the at least one filter chamber comprises a delimit protrusion on the outer surface thereof at the interface between the chamber sidewall and the front wall, each delimit protrusion having a frustum shape.

13. (canceled)

14. (canceled)

15. The respirator apparatus of claim 1 further comprising:
at least one reusable and resterilizable strap harness demountably attachable to the chamber sidewall of a corresponding one of the at least one filter chamber, the at least one strap harness comprising a plurality of fastening anchors.

16. The respirator apparatus of claim 15, wherein any concave section of the at least one strap harness comprises a smoothly curved contour or comprises an obtuse angle measured between two tangential lines thereof.

17. The respirator apparatus of claim 15, wherein the chamber sidewall of each of the at least one filter chamber comprises a delimit protrusion on the outer surface thereof at the interface between the chamber sidewall and the front wall; and wherein each of the at least one strap harness comprises a delimiter radially outwardly extending a body thereof, the delimiter comprising a rearwardly and radially inwardly facing recess for coupling to the delimit protrusion of the corresponding chamber sidewall.

18. The respirator apparatus of claim 17, wherein each delimiter has a shape substantially corresponding to that of the delimit protrusion of the corresponding chamber sidewall.

19. The respirator apparatus of claim 15, wherein each filter cap is configured for securing a corresponding one of the at least one strap harness to the corresponding chamber sidewalk and wherein each filter cap comprises a mark for indicating the filter cap being secured to the corresponding chamber sidewall.

20. (canceled)

21. (canceled)

22. (canceled)

23. (canceled)

24. (canceled)

25. The respirator apparatus of claim 15 further comprising:
one or more reusable and resterilizable mounting structures for demountably coupling to the plurality of fastening anchors;
wherein any concave section of the one or more mounting structures comprises a smoothly curved contour or comprises an obtuse angle measured between two tangential lines thereof.

26. (canceled)

27. (canceled)

28. (canceled)

29. The respirator apparatus of claim 1 further comprising:
a face shield comprising at least one opening for demountably coupling to the chamber sidewall of the at least one filter chamber for demountably coupling the face shield to the mask body;
wherein the at least one filter cap is configured for securing the face shield to the mask body.

30. (canceled)

31. The respirator apparatus of claim 1 further comprising:
one or more communication components for communicating with a communication device.

32. The respirator apparatus of claim 1, wherein the one or more communication components comprise at least one of one or more automatic-identification-and-data-capture (AIDC) sensors, one or more radio-frequency identification (RFID) tags, and one or more near-field communication (NFC) circuitries.

33. (canceled)

34. (canceled)

35. The respirator apparatus of claim 1 further comprising at least one of:
one or more temperature sensors; and
one or more bio-sensors for detecting infectious agents from air of a user's breath.

36. (canceled)

37. A system comprising:
one or more respirator apparatuses of claim 31; and
one or more computing devices for communicating with the one or more communication components of the one or more respirator apparatuses for at least one of:
tracking usage of the one or more respirator apparatuses and/or inventory management thereof; and
collecting temperature data from one or more temperature sensors of the one or more respirator apparatuses for tracking use conditions of the one or more respirator apparatuses.

38. (canceled)

39. The system of claim 37, wherein the one or more computing devices are configured for at least one of:
determining that one of the one or more respirator apparatuses is in use if the temperature data collected therefrom is within a range of human body temperatures;
determining, based on the temperature data collected from one of the one or more respirator apparatuses, a health condition of a user of the respirator apparatus; and
determining, based on the temperature data collected from one of the one or more respirator apparatuses, that the respirator apparatus is in a reprocessing or reconditioning cycle in an environment of a predefined temperature.

40. (canceled)

41. (canceled)

42. A respirator apparatus comprising:
a mask body, the mask body comprising a front wall with at least one filter chamber thereon for receiving therein at least one filter cartridge, each of the at least one filter chamber comprising a chamber sidewall extending outwardly from the front wall;
at least one filter cap demountably attachable to the chamber sidewall of a corresponding one of the at least one filter chamber for securing the at least one filter cartridge in the corresponding filter chamber; and
at least one strap harness demountably attachable to the chamber sidewall of a corresponding one of the at least one filter chamber, the at least one strap harness comprising a plurality of fastening anchors.
